(19) United States
(12) Patent Application Publication
(10) Pub. No.: US 2014/0287874 A1
(43) Pub. Date: Sep. 25, 2014

(54) CONTROL APPARATUS FOR VEHICLE

(71) Applicants: Hiroki NAKANO, Toyota-shi (JP); Tetsuya TOYODA, Okazaki-shi (JP)

(72) Inventors: Hiroki NAKANO, Toyota-shi (JP); Tetsuya TOYODA, Okazaki-shi (JP)

(73) Assignee: TOYOTA JIDOSHA KABUSHIKI KAISHA, Toyota-shi (JP)

(21) Appl. No.: 14/218,042

(22) Filed: Mar. 18, 2014

(30) Foreign Application Priority Data
Mar. 21, 2013 (JP) 2013-057636

(51) Int. Cl. B60W 10/06; B60W 10/18

(52) U.S. Cl. CPC B60W 10/06; B60W 10/18
USPC 477/200

(57) ABSTRACT

A control apparatus for a vehicle includes: a controller configured to automatically stop an engine based on a condition that includes depressing a brake pedal, the controller configured to restart the engine in response to a state where the brake pedal is released without being depressed further after the engine is automatically stopped, the controller configured to maintain the engine at a standstill in case the brake pedal is depressed further after the engine is automatically stopped even if the brake pedal is released.

### INCORPORATION BY REFERENCE

The disclosure of Japanese Patent Application No. 2013-057636 filed on Mar. 21, 2013 including the specification, drawings and abstract is incorporated herein by reference in its entirety.

### BACKGROUND OF THE INVENTION

1. Field of the Invention

The present invention relates to a control apparatus for a vehicle and more particularly to a technique for maintaining an internal combustion engine at a standstill which is automatically stopped by an idle-stop function of the vehicle.

2. Description of Related Art

Some vehicles are provided with an idle-stop system or function, also commonly known as a start-stop system, which automatically stops the engine when the vehicle stops in order to reduce fuel consumption. For example, the engine is automatically stopped on condition that the brake pedal is depressed. During idle stop, if a driver needs to continue to depress the brake pedal in order to maintain the engine at a standstill, this may increase a burden on the driver.

In order to reduce the burden on the driver, Japanese Patent Application Publication No. 2012-102647 (JP 2012-102647 A) discloses a technique in which the engine does not restart even when the brake pedal is released but the engine restarts when other restart conditions are satisfied.

### SUMMARY OF THE INVENTION

However, according to the technique disclosed in JP 2012-102647 A, the determination is not made whether the driver wants to restart the engine or to maintain the engine at a standstill when releasing the brake pedal. Thus, even if the driver wants to restart the engine, the engine does not restart even though the driver releases the brake pedal. On this account, the related art needs improvements in order to meet the demands of the driver to drive off immediately.

The present invention is provided to reduce the burden on the driver and to achieve the instant restart of the engine.

In one aspect of the present invention, a control apparatus for a vehicle includes: a controller configured to automatically stop an engine based on a condition that includes depressing a brake pedal, the controller configured to restart the engine in response to a state where the brake pedal is released without being depressed further after the engine is automatically stopped, the controller configured to maintain the engine at a standstill in case the brake pedal is depressed further after the engine is automatically stopped even if the brake pedal is released. In order to determine whether the brake pedal is depressed further, the restart of the engine or maintaining the engine at a standstill can be selected by the operation of the brake pedal only. Therefore, the present invention can reduce the burden on the driver and achieve the instant restart of the engine.

The control apparatus for a vehicle according to another aspect of the present invention may be in which the controller is configured to maintain braking force of the vehicle in case the brake pedal is depressed further after the engine is automatically stopped. Since the braking force is maintained, the vehicle can be prevented from moving backward in an uphill road and the like.

The control apparatus for a vehicle according to still another aspect of the present invention may be in which the controller is configured to restart the engine if the brake pedal is depressed again while the engine remains at a standstill and then the brake pedal is released. The engine can accordingly be restarted by the operation of the brake pedal only.

The control apparatus for a vehicle according to yet another aspect of the present invention may be in which the controller is configured to restart the engine if specified restart conditions other than release of the brake pedal are satisfied while the engine remains at a standstill. Even when the engine remains at a standstill, other restart conditions are satisfied and thus the engine can be started. Therefore, the vehicle can be restarted immediately.

The control apparatus for a vehicle according to further aspect of the present invention may be in which the controller is configured to receive a detection signal transmitted by a sensor that detects an operating state of the brake pedal, the sensor detecting the operating state of the brake pedal is any of a hydraulic sensor, a stroke sensor, and a pedaling force sensor. The control apparatus can accordingly detect the state of the brake pedal as a processable signal.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram of a vehicle;

FIG. 2 is a diagram that shows an electronic control unit (ECU);

FIG. 3 is a first graph that shows the operation amount of the brake pedal and the state of the engine;

FIG. 4 is a second graph that shows the operation amount of the brake pedal and the state of the engine;

FIG. 5 is a diagram that shows control states of the engine;

FIG. 6 is a first flowchart that shows processes executed by the ECU; and

FIG. 7 is a second flowchart that shows processes executed by the ECU.

### DETAILED DESCRIPTION OF EMBODIMENTS

Hereinafter, embodiments of the present invention will be described with reference to the drawings. In the descriptions below, the same components are denoted with the same reference numerals and symbols. Names and functions of the same components are identical with each other. Thus, the detailed description for those components will not be repeated.

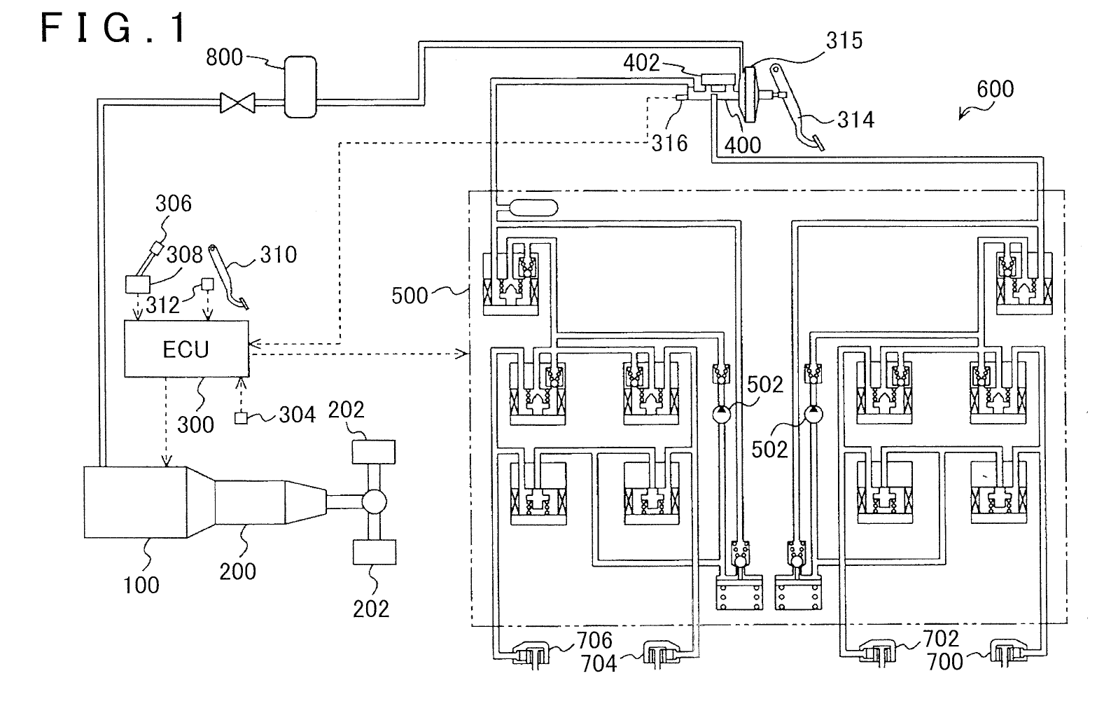

Referring to FIG. 1, the vehicle includes an internal combustion engine 100 and a transmission 200. Torque generated by the engine 100 is transferred to wheels 202 through the transmission 200.

The engine 100 is controlled by an electronic control unit (ECU) 300. The ECU 300 receives signals representing detection results from a vehicle speed sensor 304, a position switch 308 that detects the position of a gear stick 306, an accelerator position sensor 312 that detects an accelerator operation amount of an accelerator pedal 310, and a hydraulic sensor 316 that detects hydraulic pressure supplied from a master cylinder 400. In this embodiment, the hydraulic sensor 316 detects whether a brake pedal 314 is depressed or released. In other words, the hydraulic pressure supplied from the master cylinder 400 is detected as the operation amount of the brake pedal 314. In place of the hydraulic sensor 316, a stroke sensor that detects the operation amount of the brake pedal 314 directly or a pedaling force sensor that detects the pedaling force applied to the brake pedal 314 can be used.

The brake pedal 314 is connected to the master cylinder 400 through a brake booster 315. A hydraulic circuit 600 that includes the master cylinder 400 and a brake actuator 500 connected to the master cylinder 400 is filled with a brake fluid (brake oil). The brake fluid (brake oil) is stored in a reservoir tank 402.

The hydraulic pressure generated in the master cylinder 400 is directed to brake calipers 700 to 706 that are disposed in the wheels through the brake actuator 500. The brake calipers 700 to 706 generate braking force by the application of the hydraulic pressure.

The brake actuator 500 controls opening and closing of solenoid valves and thus controls the hydraulic pressure of the brakes by directing the hydraulic pressure generated by pumps 502 to the brake calipers. The brake actuator 500 is controlled by the ECU 300.

The brake booster 315 is connected to a negative pressure tank 800. The negative pressure tank 800 retains the negative pressure that is generated in the engine 100. The brake booster 315 increases the pedaling force applied to the brake pedal 314 and transfers it to the master cylinder 400.

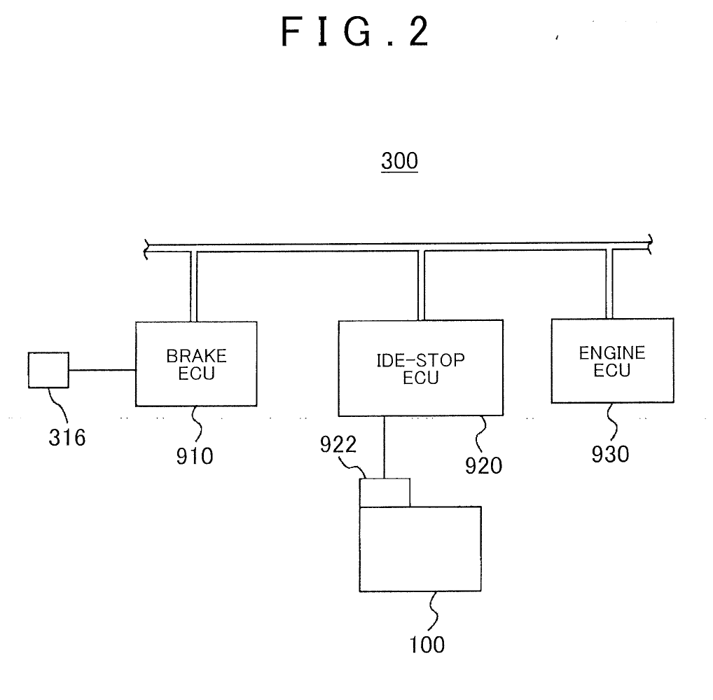

Referring to FIG. 2, the ECU 300 is described furthermore. The ECU 300 includes a brake ECU 910, an idle-stop ECU 920, and an engine ECU 930. The brake ECU 910, the idle-stop ECU 920, and the engine ECU 930 are connected so as to be capable of communication with each other through controller area network (CAN) lines.

The brake ECU 910 receives a detection signal of the hydraulic pressure from the hydraulic sensor 316 directly. The brake ECU 910 controls the brake actuator 500 in accordance with the signals transmitted by the hydraulic sensor 316 and the other components.

The idle-stop ECU 920 makes a request for an automatic stop of the engine 100 to the engine ECU 930 when specified idle-stop conditions are satisfied including at least a condition where the brake pedal 314 is depressed. For example, when all conditions are satisfied where the brake pedal 314 is depressed, the vehicle speed is zero, and the steering angle of a steering wheel is zero, it is determined that the idle-stop conditions are satisfied.

In addition, the idle-stop ECU 920 makes a request for a restart of the engine 100 to the engine ECU 930 when specified restart conditions are satisfied and allows a starter 922 to be driven in order to crank the engine 100.

The engine ECU 930 controls fuel injection quantity, a throttle operation amount, and ignition timing during the operation of the engine 100 and thus operates the engine 100 in a desired state. The engine ECU 930 stops fuel injection and ignition in order to stop the engine 100 when receiving the request for the stop of the engine 100 from the idle-stop ECU 920.

In addition, the engine ECU 930 restarts fuel injection and ignition in order to start the engine 100 when receiving the request for the restart of the engine 100 from the idle-stop ECU 920.

However, if a driver needs to depress the brake pedal 314 all the time during the stop in order to maintain the engine 100 at a standstill, this may result in a burden on the driver. On the other hand, if the restart of the engine 100 is prevented even when the driver releases the foot from the brake pedal 314, the vehicle cannot be started as desired by the driver when the driver wants to drive off immediately.

Therefore, in order to reduce the burden on the driver and to achieve the instant restart of the engine 100, this embodiment allows the driver to select control modes of the engine 100 by operation modes of the brake pedal 314 after the engine 100 is automatically stopped.

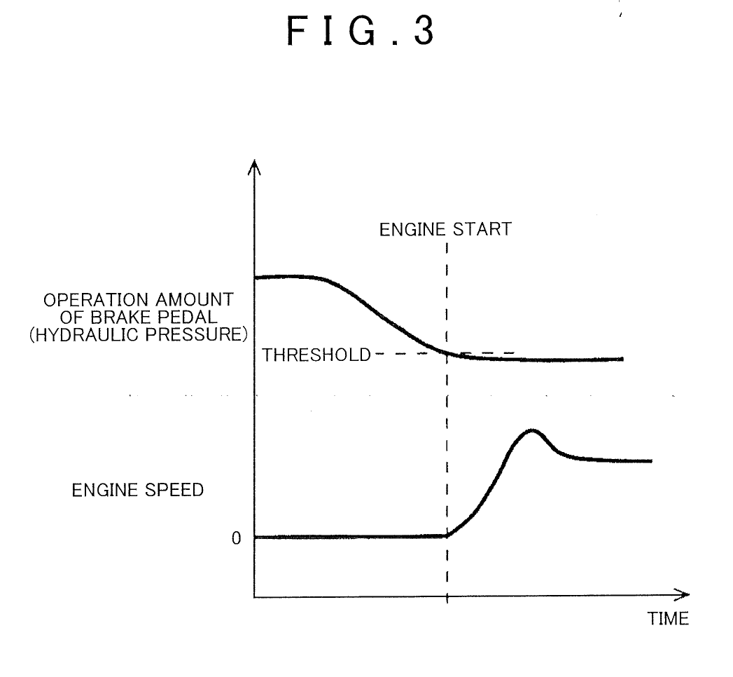

More specifically, as shown in FIG. 3, when the brake pedal 314 is released without being depressed further after the engine 100 is automatically stopped, the engine 100 restarts.

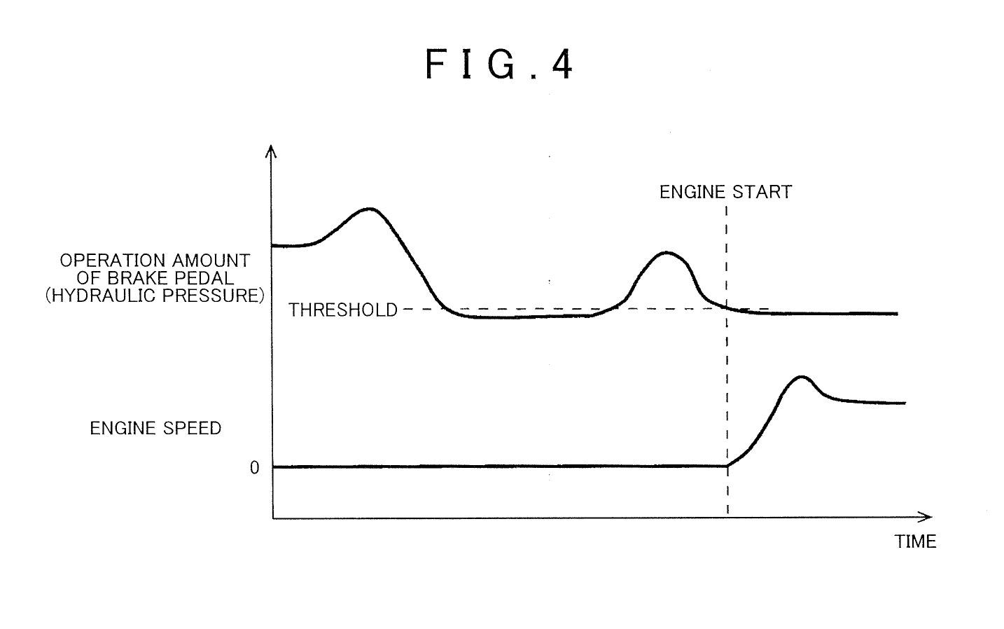

On the other hand, as shown in FIG. 4, when the brake pedal 314 is depressed further after the engine 100 is automatically stopped, the engine 100 remains at a standstill even when the brake pedal 314 is released. If the brake pedal 314 is depressed again when the engine 100 remains at a standstill, the brake pedal 314 is released and thus the engine 100 restarts.

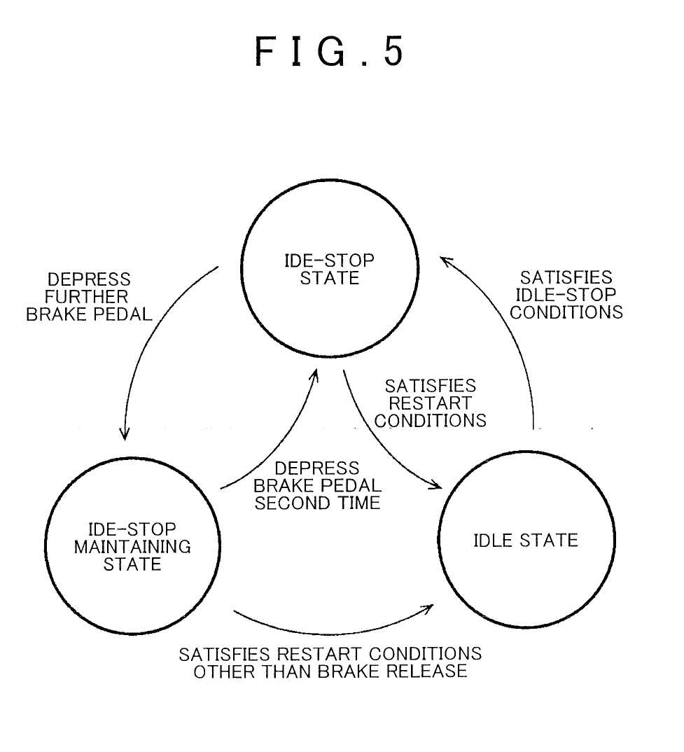

The aforementioned control modes are described furthermore with reference to FIG. 5. If the idle-stop conditions are satisfied when the engine 100 idles, the engine 100 is automatically stopped, and a transition of a control state to an idle-stop state occurs.

When the restart conditions of the engine 100 are satisfied in the idle-stop state, the engine 100 restarts, and the control state returns to an idle state. In this embodiment, one of the restart conditions is a release of the brake pedal 314. Thus, when the brake pedal 314 is released in the idle-stop state (when the operation amount of the brake pedal 314 decreases), the engine 100 restarts, and the control state returns to an idle state. Even when the restart conditions other than the release of the brake pedal 314 are satisfied, the engine 100 restarts, and the control state returns to an idle state.

On the other hand, when the brake pedal 314 is depressed further in the idle-stop state (when the operation amount of the brake pedal 314 increases), the transition of the control state to an idle-stop maintaining state occurs. In the idle-stop maintaining state, even if the brake pedal 314 is released, the engine 100 does not restart but remains at a standstill.

Once the brake pedal 314 is released in the idle-stop maintaining state and then the brake pedal 314 is depressed again, the transition of the control state to the idle-stop state occurs. Since the transition of the control state to the idle-stop state occurs, the engine 100 restarts by the release of the brake pedal 314, as described above.

In the idle-stop maintaining state, the engine 100 does not restart even if the brake pedal 314 is released; however, when the specified restart conditions other than the release of the brake pedal 314 are satisfied such as depressing of the accelerator pedal 310 (increase in the accelerator pedal operation amount) and operation of the steering wheel (increase in the steering angle), the engine 100 restarts. In other words, if the specified restart conditions other than the release of the brake pedal 314 are satisfied when the engine 100 remains at a standstill, the engine 100 restarts.

In the idle-stop maintaining state, the brake ECU 910 controls the brake actuator 500 so as to maintain the braking force of the vehicle. Consequently, in the idle-stop maintaining state, the braking force of the vehicle can be maintained even when the brake pedal 314 is released. That is to say, when the brake pedal 314 is depressed further after the engine 100 is automatically stopped, the braking force of the vehicle is maintained.

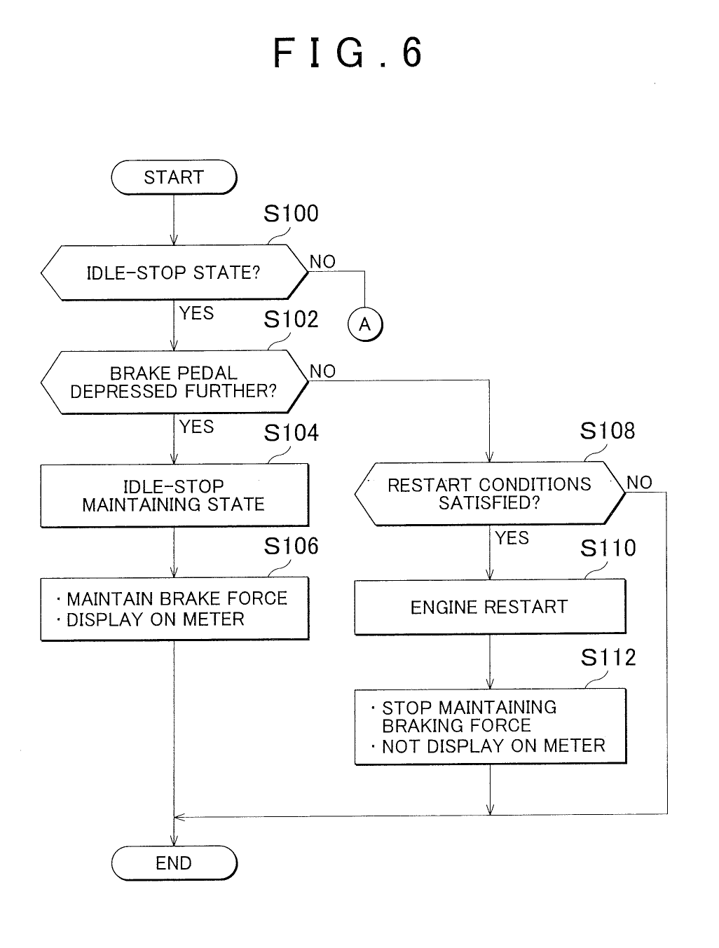

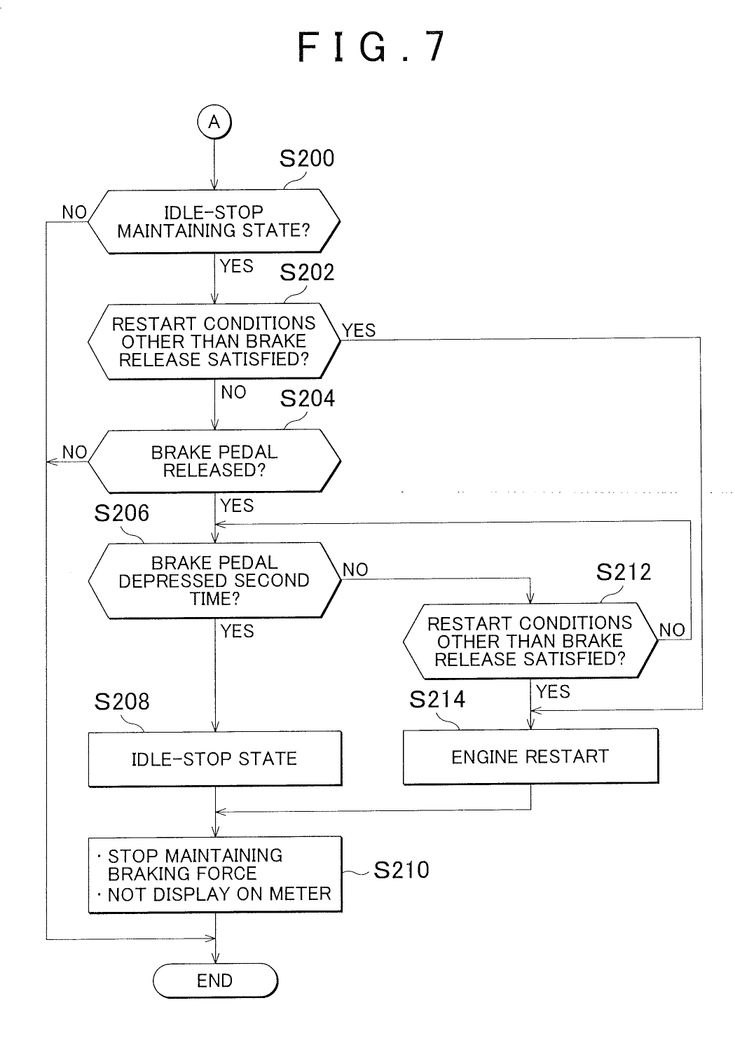

Referring to FIGS. 6 and 7, the processes executed by the ECU 300 in this embodiment are described. The processes described below are repeatedly executed in specified cycles.

In a step (hereinafter, the step is abbreviated as “S”) 100, it is determined whether the control state of the engine 100 is in the idle-stop state. When the control state is in the idle-stop state (YES in S100), it is determined in S102 whether the brake pedal 314 is depressed further. More specifically, it is determined whether the hydraulic pressure supplied from the master cylinder 400 (hereinafter, also referred to as a “master pressure”) is greater than a specified threshold SH1, for example. The threshold SH1 used in S102 is determined by developers from the result of experiment. For example, the threshold SH1 is determined so as to be greater than the hydraulic pressure required for the vehicle to remain at a standstill. It may be determined whether an increasing rate of the hydraulic pressure is greater than a specified increasing rate P1, instead of whether the hydraulic pressure is greater than the threshold SH1.

When the brake pedal 314 is depressed further (YES in S102), the transition of the control state to the idle-stop maintaining state occurs in S104. Additionally, the braking force of the vehicle is maintained and it is displayed on a meter or a display that is disposed in an instrument panel on a front side of a cabin, in S106.

On the other hand, when the brake pedal 314 is not depressed further (NO in S102) and the brake pedal 314 is released until the master pressure becomes zero, for example (YES in S108), the engine 100 restarts in S110, and the transition of the control state to the idle state occurs. In the idle state, the braking force is not maintained, and no display appears such that the braking force is maintained (S112).

When the control state is not in the idle-stop maintaining state (NO in S100), it is determined in S200 whether the control state is in the idle-stop maintaining state. When the control state is in the idle-stop maintaining state (YES in S200), it is determined in S202 whether the specified restart conditions other than the release of the brake pedal 314 are satisfied.

When the specified restart conditions other than the release of the brake pedal 314 are not satisfied (NO in S202), it is determined in S204 whether the brake pedal 314 is released. More specifically, for example, it is determined whether the master pressure is lower than a specified threshold SH2. The threshold SH2 used in S204 is determined so as to be smaller than the threshold SH1 used in S102 by developers from the result of experiment.

When the brake pedal 314 is released (YES in S204), it is determined in S206 whether the brake pedal 314 is depressed further. More specifically, for example, it is determined whether the master pressure is greater than the specified threshold SH2. It may be determined whether the increasing rate of the master pressure is greater than a specified increasing rate P2 (P2<P1), instead of whether the master pressure is greater than the threshold SH2.

When the brake pedal 314 is depressed further (YES in S206), the transition of the control state from the idle-stop maintaining state to the idle-stop state occurs in S208. Furthermore, in S210, maintaining of the braking force is stopped, and the display in which the braking force is maintained is finished.

Even in the idle-stop maintaining state, when the specified restart conditions other than the release of the brake pedal 314 are satisfied (YES in S202 or S212), the engine 100 restarts in S214, and the transition of the control state from the idle-stop maintaining state to the idle state occurs.

[Reference Example] In the embodiment described above, the transition of the control state from the idle-stop state to the idle-stop maintaining state occurs by further depressing of the brake pedal 314. However, the transition of the control state may occur by operation of a switch on the steering wheel or the instrument panel or by the operation of the steering wheel.

The embodiments disclosed herein are to be considered in all respects as illustrative and not restrictive. The scope of the present invention is indicated by the appended claims rather than by the foregoing description, and all changes which come within the meaning and range of equivalency of the claims are therefore intended to be embraced therein.

What is claimed is:

1. A control apparatus for a vehicle comprising:
a controller configured to automatically stop an engine based on a condition that includes depressing a brake pedal, the controller configured to restart the engine in response to a state where the brake pedal is released without being depressed further after the engine is automatically stopped, the controller configured to maintain the engine at a standstill in case the brake pedal is depressed further after the engine is automatically stopped even if the brake pedal is released.

2. The control apparatus for a vehicle according to claim 1, wherein the controller is configured to maintain braking force of the vehicle in case the brake pedal is depressed further after the engine is automatically stopped.

3. The control apparatus for a vehicle according to claim 1, wherein the controller is configured to restart the engine if the brake pedal is depressed again while the engine remains at a standstill and then the brake pedal is released.

4. The control apparatus for a vehicle according to claim 1, wherein the controller is configured to restart the engine if specified restart conditions other than release of the brake pedal are satisfied while the engine remains at a standstill.

5. The control apparatus for a vehicle according to claim 1, wherein the controller is configured to receive a detection signal transmitted by a sensor that detects an operating state of the brake pedal, the sensor detecting the operating state of the brake pedal is any of a hydraulic sensor, a stroke sensor, and a pedaling force sensor.
